(19) United States
(12) Patent Application Publication
(10) Pub. No.: US 2018/0081811 A1
(43) Pub. Date: Mar. 22, 2018

(54) DYNAMIC CACHE PARTITIONING THROUGH HILL-CLIMBING

(71) Applicant: QUALCOMM Incorporated, San Diego, CA (US)

(72) Inventors: Rami Mohammad A. AL SHEIKH, Morrisville, NC (US); Harold Wade CAIN, III, Raleigh, NC (US)

(21) Appl. No.: 15/271,161

(22) Filed: Sep. 20, 2016

(51) Int. Cl. G06F 12/0846; G06F 12/123; G06F 12/084; G06F 12/128

(52) U.S. Cl. CPC G06F 12/0848; G06F 12/123; G06F 12/084; G06F 2212/282; G06F 2212/69; G06F 2212/314; G06F 12/128

(57) ABSTRACT

Systems and methods for dynamically partitioning a shared cache, include dynamically determining a probability to be associated with each one of two or more processors configured to access the shared cache. Based on the probability for a processor, a first cache line of the processor is inserted in a most recently used (MRU) position of a least recently used (LRU) stack associated with the shared cache, pursuant to a miss in the shared cache for the first cache line. Based on the probability for the processor, a second cache line is promoted to the MRU position of the LRU stack, pursuant to a hit in the shared cache for the second cache line. The probability for the processor is determined based on hill-climbing, wherein fluctuations in the probability are reduced, local maxima are prevented, and the probability is prevented from falling below a threshold.

### FIELD OF DISCLOSURE

Disclosed aspects are directed to cache memories in processing systems. More specifically, exemplary aspects are directed to dynamic partitioning of a shared cache among two or more processors using a gradient-based or hill-climbing approach.

### BACKGROUND

A processing system may comprise one or more processors which can make requests for accessing data stored in a memory (e.g., a main memory or hard disk). Memory requests generated by a processor may display temporal locality, which means that the requests are directed to data which was recently requested, and correspondingly also means that the same data may be requested again in the near future. To exploit temporal locality, one or more caches may be provided to store data which is determined to have likelihood of future use. The caches may be designed to be small in size to enable high speeds (e.g., in the order of few tens of clock cycles, as compared to memory access speeds which can be in the order of hundreds or thousands of clock cycles).

Since the caches are designed to be small, the limited storage space in the caches may be filled up, which means that some cache lines may need to be evicted (called victim cache lines) to accommodate incoming cache lines (called contender cache lines). Cache replacement policies are known in the art for evicting the victim cache lines and replacing them with the contender cache lines. Some cache replacement policies such as least recently used (LRU) replacement policies rely on the temporal locality of the data requested, and may evict cache lines which were not accessed for the longest period of time.

In an implementation of the LRU policy, a stack (referred to as an “LRU stack”) is associated with the cache lines. The LRU stack maintains an indication of how recently each cache line in a cache was used, and may sort the cache lines in a descending order of most recently used (MRU) to least recently used (LRU), for example. On a cache miss (i.e., a desired incoming cache line is not present in the cache), the least recently used cache line, or in other words, the cache line associated with the LRU position of the LRU stack is evicted and the incoming cache line is inserted and associated with the MRU position of the LRU stack. On a cache hit (i.e., an incoming cache line is already present in the cache), the position of the accessed cache line in the LRU stack is promoted to the MRU position.

In cases where the cache is a shared cache (e.g., a last-level cache such as an L3 cache), shared amongst multiple processors in chip-multi-processor (CMP) systems, for example the proportion of the shared cache allocated to each processor can be effectively based on the positions in the LRU stack associated with cache lines of each processor. This can be understood by recognizing that the position in the LRU stack associated with a cache line of a processor determines how long the cache line is likely to survive in the shared cache; thus if more cache lines of a processor survive longer in the shared cache due to their higher positions in the LRU stack (i.e., closer to the MRU position) then that processor will have proportionally higher storage space in the shared cache.

Since the shared cache is a resource in high demand, the multiple processors may compete for the shared cache. Allocation of the storage space of the shared cache among the multiple processors may either be uncontrolled (e.g., in a truly-shared, free-for-all fashion where no cache partitioning is enforced but each processor is allowed to allowed to compete with the other processors in an unchecked manner), or mechanisms may be put in place to supervise the allocation (e.g., a predetermined partitioning of the shared cache among the multiple processors may be enforced). However, these approaches do not take into account the different behaviors, requirements, access patterns, reuse patterns, etc., of the various applications or programs on the multiple processors which access the shared cache. For example, different applications may be associated with different cache footprints (i.e., the amount of storage space occupied in the shared cache by cache lines of the applications). Furthermore, the footprints of the applications may change over time, and so a predetermined static partitioning of the shared cache among the multiple processors may be ineffective over time.

Some approaches for dynamic cache partitioning (see, e.g., Hasenplaugh et al., “The Gradient-Based Cache Partitioning Algorithm,” ACM Trans. Architec. Code Optim. 8, 4, Article 44 (January 2012), hereinafter referred to as, “Hasenplaugh”) attempt to control the probability with which a cache line inserted into a shared cache is associated with the MRU position in the LRU stack of the shared cache (referred to simply as the probability of insertion of the cache line in the MRU position). The closer to the MRU position the cache is in the cache, the less likely it is that the cache line will be replaced. Viewed another way, by inserting a cache line in a low position in the LRU stack (or having a low probability of insertion of the cache line in the MRU position), the remaining cache lines which are in higher positions in the LRU stack are protected from being replaced or evicted by the inserted cache line. In Hasenplaugh, probability of insertion in the MRU position of cache lines of various applications in a shared cache is controlled, in an attempt to dynamically partition the shared cache among the various applications.

However, approaches such as Hasenplaugh's suffer from various limitations. For example, Hasenplaugh's approach does not control the changes in positions of cache lines in the LRU stack when hits are observed for the cache lines; rather, Hasenplaugh always promotes hitting cache lines to the MRU position in the LRU stack, based on the notion that a cache line is the most recently accessed or most recently used when there is a hit for the cache line. However, always promoting hitting cache lines to the MRU position can give rise to scenarios where the proportion of the shared cache occupied by a processor or application whose cache lines generate a lot of hits is allowed to increase in an unchecked manner, which can result in edging out other applications which do not generate as many hits. Further, Hasenplaugh's approach can also allow the probability of associating older cache lines with the MRU position to drop in an unchecked manner, which can also starve related applications from receiving their fair or intended share of the shared cache.

Furthermore, Hassenplauh's approach does not differentiate between different types of cache access requests. For example, non-demand requests (such as prefetches and write-backs to the shared cache) are afforded the same preference or probability of insertion in the MRU position, as demand requests. This approach is seen to be ineffective because cache misses for non-demand requests may not impact the performance of associated processors as severely as cache misses for demand requests may. Thus, with these approaches, non-demand requests may take up valuable resources on the shared cache at the expense of preventing demand requests from receiving a desired amount of the cache space, which can lead to performance deteriorations.

Accordingly, there is a need for dynamic partitioning techniques for shared caches which avoid the above drawbacks of known approaches.

### SUMMARY

Exemplary aspects of the invention are directed to systems and methods for dynamically partitioning a shared cache, include dynamically determining a probability to be associated with each one of two or more processors configured to access the shared cache. Based on the probability for a processor, a first cache line of the processor is inserted in a most recently used (MRU) position of a least recently used (LRU) stack associated with the shared cache, pursuant to a miss in the shared cache for the first cache line. Based on the probability for the processor, a second cache line is promoted to the MRU position of the LRU stack, pursuant to a hit in the shared cache for the second cache line. The probability for the processor is determined based on hill-climbing, wherein fluctuations in the probability are reduced, local maxima are prevented, and the probability is prevented from falling below a threshold. Furthermore, non-demand cache lines are inserted into a low segment of the LRU stack.

For example, an exemplary aspect is directed to a method of dynamically partitioning a shared cache, the method comprising dynamically determining a probability to be associated with each one of two or more processors configured to access the shared cache. Based on the probability for a processor, a first cache line of the processor is inserted in a most recently used (MRU) position of a least recently used (LRU) stack associated with the shared cache, pursuant to a miss in the shared cache for the first cache line; and based on the probability for the processor, a second cache line is promoted to the MRU position of the LRU stack, pursuant to a hit in the shared cache for the second cache line.

Another exemplary aspect is directed to an apparatus comprising a shared cache configured to be accessed by two or more processors, and a cache controller configured to dynamically partition the shared cache among the two or more processors. The cache controller configured to dynamically determine a probability to be associated with each one of the two or more processors, insert, based on the probability for a processor of the two or more processors, a first cache line of the processor in a most recently used (MRU) position of a least recently used (LRU) stack associated with the shared cache, pursuant to a miss in the shared cache for the first cache line, and promote, based on the probability for the processor, a second cache line to the MRU position of the LRU stack, pursuant to a hit in the shared cache for the second cache line.

Another exemplary aspect is directed to an apparatus comprising a shared cache accessible by two or more processors, means for dynamically determining a probability to be associated with each one of two or more processors, means for inserting, based on the probability for a processor, a first cache line of the processor in a most recently used (MRU) position of a least recently used (LRU) stack associated with the shared cache, pursuant to a miss in the shared cache for the first cache line, and means for promoting, based on the probability for the processor, a second cache line to the MRU position of the LRU stack, pursuant to a hit in the shared cache for the second cache line.

Yet another exemplary aspect is directed to a non-transitory computer readable storage medium comprising code, which, when executed by a processing element, causes the processing element to perform operations for dynamically partitioning a shared cache, non-transitory computer readable storage medium comprising code for dynamically determining a probability to be associated with each one of two or more processors configured to access the shared cache, code for inserting, based on the probability for a processor, a first cache line of the processor in a most recently used (MRU) position of a least recently used (LRU) stack associated with the shared cache, pursuant to a miss in the shared cache for the first cache line, and code for promoting, based on the probability for the processor, a second cache line to the MRU position of the LRU stack, pursuant to a hit in the shared cache for the second cache line.

### BRIEF DESCRIPTION OF THE DRAWINGS

The accompanying drawings are presented to aid in the description of aspects of the invention and are provided solely for illustration of the aspects and not limitation thereof.

FIG. 1 depicts an exemplary processing system according to aspects of this disclosure.

FIG. 2 depicts dynamic partitioning of a shared cache of an exemplary processing system according to aspects of this disclosure.

FIG. 3 depicts an exemplary method for dynamic cache partitioning, according to aspects of this disclosure.

FIG. 4 depicts an exemplary computing device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to techniques for partitioning a shared cache among multiple applications. In addition to controlling the probability with which a cache line inserted into a shared cache is associated with a MRU position of a LRU stack associated with the shared cache (or simply, the “probability of insertion” of the cache line in the MRU position), e.g., pursuant to a miss in the shared cache, in exemplary aspects, the probability with which the position associated with a cache line in the LRU stack is promoted to the MRU position (or simply, the “probability of promotion” of the cache line to the MRU position), e.g., pursuant to a hit in the shared cache, is also controlled.

Exemplary aspects of dynamic cache partitioning also include additional optimizations and improvements over conventional approaches. For example, cache lines associated with non-demand requests (e.g., prefetches and write-backs to a shared cache such as a last-level-cache) are inserted into a lower segment of the LRU stack (i.e., inserted with a low probability of being associated with the MRU position). The probability of insertion, as well as promotion of cache lines are also prevented from falling below a specified threshold, in order to ensure that some processors or applications are not inadvertently starved. Furthermore, hill-climbing or gradient-based adjustments of probability of insertion and promotion of cache lines are protected from the probabilities getting stuck at local maxima. These and related aspects will now be further explained with reference to the figures.

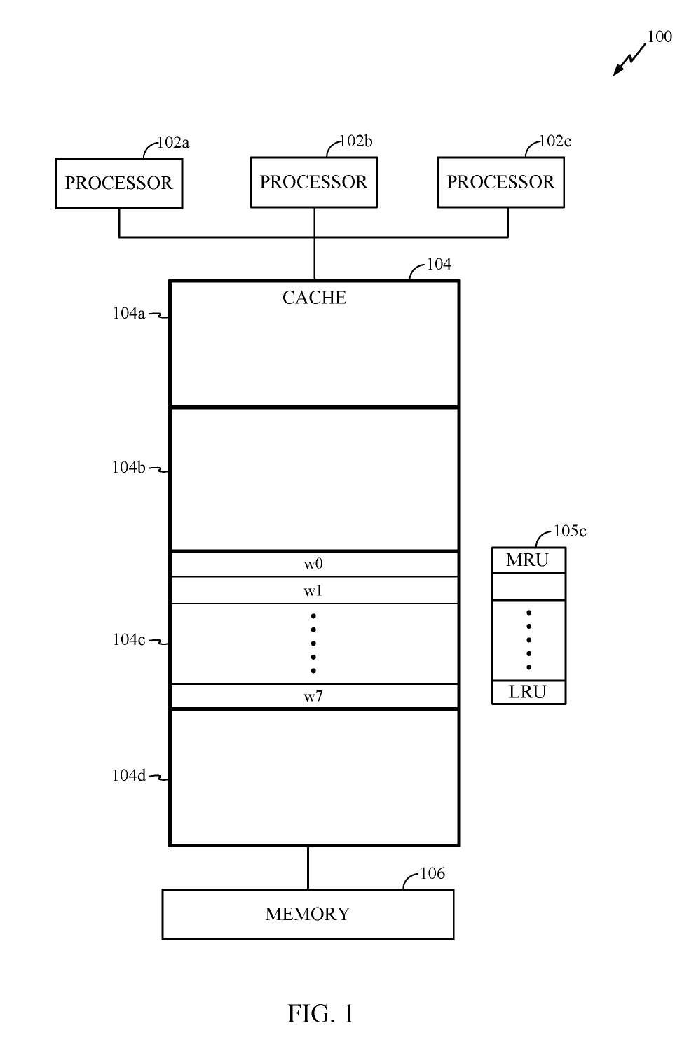

With reference to FIG. 1, exemplary processing system 100 is illustrated with multiple processors 102a-c, cache 104, and memory 106 representatively shown, keeping in mind that various other components which may be present have not been illustrated for the sake of clarity. Processors 102a-c have been shown for the sake of one example of multiple processors configured to access a shared cache such as cache 104, but it will be understood that processors 102a-c need not represent different processor cores (e.g., central processing units (CPUs)) but may also represent different applications or programs being executed by one or more processor cores, wherein techniques for dynamic partitioning of cache 104 among the multiple processors 102a-c may be equally applicable to dynamic partitioning of cache 104 among the various applications or programs. As such, processors 102a-c may generally be any processing element configured to make memory access requests to memory 106 which may be a main memory (e.g., dynamic random access memory, “DRAM”), and cache 104 may be one of several caches present in between processors 102a-c and memory 106 in a memory hierarchy of processing system 100. In one example, cache 104 may be a last-level cache (e.g., a level-3 or L3 cache), with one or more higher level caches such as level-1 (L1) caches and one or more level-2 (L2) caches present between processor 102a-c and cache 104, although these additional caches have not been shown in FIG. 1 for the sake of clarity.

As shown, cache 104 may be a set associative cache with four sets 104a-d shown for the sake of an example illustration. Each set 104a-d may have multiple ways of cache lines (also referred to as cache blocks). Eight ways w0-w7 of cache lines for set 104c have been representatively illustrated in the example of FIG. 1. The various ways may comprise cache lines from multiple processors 102a-c (or, as previously mentioned, from multiple applications). Dynamic partitioning of cache 104 may involve controlling the number of cache lines which may be allocated to each one of processors 102a-c. Representatively, for each set, dynamic partitioning may be explained in terms of allocation of ways w0-7 among processors 102a-c based on positions associated with ways w0-7 in an LRU stack such as LRU stack 105c, in one example which will now be explained in further detail.

The temporal locality of cache accesses may be estimated by recording an order of the cache lines in ways w0-w7 from most recently accessed or most recently used (MRU) to least recently accessed or least recently used (MRU) in LRU stack 105c. LRU Stack 105c may be a buffer or an ordered collection of registers, for example, wherein each entry of LRU stack 105c may include an indication of a way, ranging from MRU to LRU (e.g., each entry or position of stack 105c may include 3-bits to point to one of the eight ways w0-w7, such that the MRU position may point to a first way, e.g., w5, while the LRU position may point to a second way, e.g., w3, in an illustrative example). The way associated with the MRU position of LRU stack 105c is least likely to be replaced and the way associated with the LRU position of LRU stack 105c is the most likely to be replaced in a LRU replacement policy. Thus, promoting the position of a way in LRU stack 105c implies improving the longevity or life of that way in set 104c and conversely, demoting the position of the way implies reducing the life of the way in set 104c. By managing the positions of a way w0-7 in LRU stack 105c upon insertion of a cache line into the way or upon a hit for a cache line already present in the way, exemplary aspects can control dynamic partitioning of ways w0-7 among processors 102a-c.

In one aspect, each one of processors 102a-c (or more generally, each application or group of applications which access cache 104 and have cache lines to be allocated in cache 104) is assigned a probability generally designated as “β” with which cache lines of the corresponding processors 102a-c are assigned to the MRU position in LRU stack 105c. In exemplary aspects, the assignment to the MRU position with probability β includes both insertion of the cache line in the MRU position pursuant to a cache miss for the cache line as well as promotion of an already existing cache line to the MRU position, pursuant to a cache hit.

For example, if processor 102a desires access (e.g., a read/load or a write/store) to a cache line which would be in set 104c (if present in cache 104), in the event that there is a cache miss, i.e., none of ways w0-7 of set 104c have the desired cache line, then the desired cache line will be inserted in a particular way, e.g., w3 (assuming w3 was in the LRU position in LRU stack 105c and is therefore replaced by the insertion), and upon the insertion, w3 will be assigned the MRU position in LRU stack 105c with a particular probability β₁, for example, associated with processor 102a. Each one of processors 102a-c may similarly have their own probabilities (e.g., β₁, β₂, β₃, etc.), which may be dynamically changed using hill-climbing, as will be further explained below, which would in turn control the proportion of cache 104 allocated to processors 102a-c, respectively.

In exemplary aspects, if there is a hit for the desired cache line requested by processor 102a, for example, i.e., if the requested cache line is already present in set 104c, e.g., in way w1, then way w1 is promoted to the MRU position in LRU stack 105c, once again with probability β₁ associated with processor 102a.

It can thus be seen that for each processor, e.g., processors 102a-c, a corresponding probability β is the probability of inserting and promoting cache lines of respective processors 102a-c to the MRU position (or viewed another way, 100−β is the probability of assigning the cache lines to the LRU position). As can be appreciated, if β=100, this means that cache lines of the associated processor will always be inserted and promoted to the MRU position, which would represent the behavior of a shared cache which lacks dynamic partitioning. On the other hand, setting β to a value of 100 divided by the number of active processors, e.g., 100/3 in the case of three processors 102a-c, provides a statically partitioned shared cache (i.e., each one of processors 102a-c receives an equal share of cache 104, which would not vary to suit the varying and disparate needs of processors 102a-c).

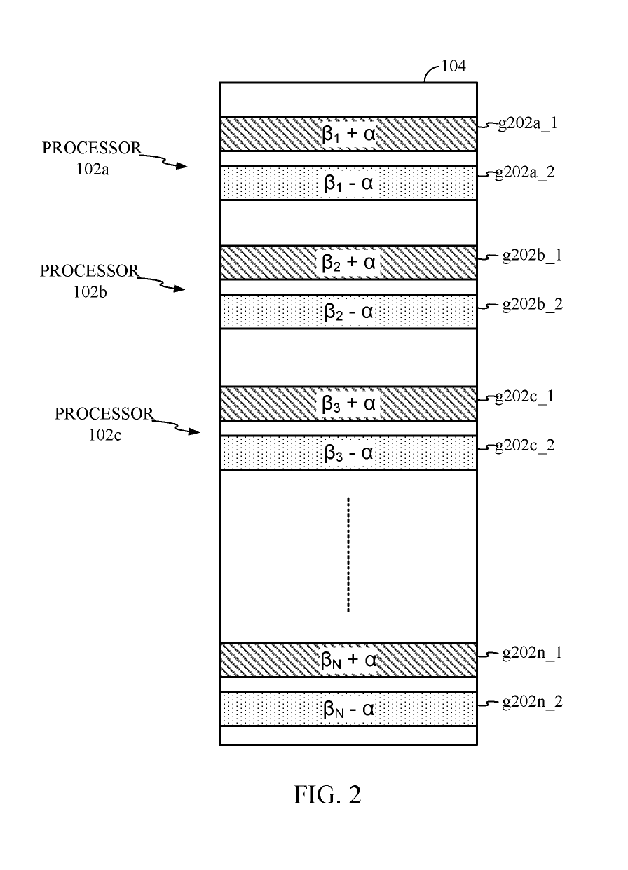

Accordingly, in exemplary aspects, the probability β is varied in a dynamic manner, wherein, a higher value of β implies a larger proportion of cache space in cache 104 for a corresponding application or processor 102a-c, and inversely, a lower value of β implies a lower proportion of cache space in cache 104 for the corresponding application or processor 102a-c. A process of hill-climbing is used to dynamically adjust how cache 104 is partitioned among processors 102a-c by adjusting the corresponding value of β for the processor (e.g., if a processor would benefit from increased cache space (i.e., a higher β) then the value of β for that processor is increased, or, if the processor's performance may not degrade if the processor is allocated less cache space (i.e., a lower β) then the value of β for that processor is decreased). To dynamically determine the value of β for each one of processors 102a-c, a process of set dueling may be employed, as will be explained with reference to FIG. 2 below.

Referring to FIG. 2 a logical view of cache 104 is shown, wherein each one of processors 102a-c may be assigned a corresponding initial value of probability β (e.g., β₀) for insertion and promotion of their respective cache lines in cache 104. Another parameter a is introduced to control increase or decrease in β for that processor 102a-c. For example, the various sets of cache 104 are divided into various groups. Each processor 102a-c is shown to be assigned two dedicated groups of a small number of sets which are non-overlapping. The two dedicated groups for each processor 102a-c are referred to as leader groups. A first leader group for a processor is assigned a positive gradient identified as β+α and a second leader group for the processor is assigned a negative gradient identified as β−α.

For example, in FIG. 2, leader groups g202a_1 (assigned a positive gradient with probability β₁+α) and g202a_2 (assigned a negative gradient with probability β₁−α) are shown for processor 102a. Similarly, leader groups g202b_1 (assigned a positive gradient with probability β₂+α) and g202b_2 (assigned a negative gradient with probability β₂−α) are shown for processor 102b; and leader groups g202c_1 (assigned a positive gradient with probability β₃+a) and g202c_2 (assigned a negative gradient with probability β₃−α) are shown for processor 102c. For the sake of illustration, additional leader groups spanning the available sets of cache 104 including g202n_1 (assigned a positive gradient with probability β_{N}+α) and g202n_2 (assigned a negative gradient with probability β_{N}−α) are also shown, and if present, these additional leader groups may be associated with other processors or applications which also access shared cache 104. From the perspective of each processor's leader groups, the remaining sets of cache 104 are referred to as follower groups. The probability β for the follower groups of a processor is based on the better performing one of the probabilities of respective leader groups of the processor (e.g., for processor 102a, if sets of leader group g202a_1 have more cache hits then the sets of leader group g202a_2, then the sets with positive gradient β₁+α may be determined to be better performing than the sets with negative gradient β₁−α). This approach is referred to as set dueling, and will be explained below with illustrative examples.

In general, for each processor, if it is determined that increasing the respective probability β for the processor would lead to better performance, e.g., in terms of more hits in cache 104, the probability β of that processor may be increased. On the other hand, if it is determined that reducing the probability β for the processor would not degrade the processor's performance, then the probability β for the processor may be decreased. In one implementation, determining whether there should be an increase in probability β, e.g., for the follower groups of a processor may be based on the performance of the first leader group with a positive gradient β+α for the processor, and inversely, decreasing the probability β for the follower groups of the processor may be based on the performance of the second leader group with a negative gradient β a for the processor.

It is possible to set a to a small percentage value between 0 and 100, e.g., 10% to implement the above process of determining whether to increase or decrease the corresponding probability β for a follower group. However, doing so can lead to the probabilities of some processors getting stuck at local maxima, i.e., some leader groups with a positive gradient may saturate to 100% if there are more hits for cache lines of those processors. To avoid such undesirable scenarios, in exemplary aspects, a is chosen to be 100%, which would effectively bring the positive gradient β+α for each one of the first leader groups to 100% and the negative gradient β−α for each one of the second leader groups to 0%. Thus, the positive and negative gradients for each one of the respective leader groups are equalized, which would avoid local maxima from developing; and the respective probabilities β of the follower groups can be increased or decreased in manners which will be further explained below, without being affected by local maxima of respective leader groups.

To illustrate an exemplary aspect where a is selected to have a fixed value of 100%, for each one of processors 102a-c, respective first leader groups g202a_1, g202b_1, and g202c_1 will have a positive gradient β₁+α=β₂+α=β₃+α=100%, or generally, 13+α=100% (which means that cache lines of the processors 102a-c for these first leader groups are always inserted at the MRU position of LRU stack 105 on cache misses, and they are also always promoted to the MRU position on hits); and the respective second leader groups g202a_2, g202b_2, and g202c_2 will have a negative gradient, β₁−α=β₂−α=β₃−α=0%, or more generally, β−α=0% (which means that cache lines of the processors 102a-c for these second leader groups are always inserted at the LRU position on misses and never promoted to the MRU position on hits).

For deciding whether to increase or decrease probability β for the respective follower groups of each one or processors 102a-c, two counters are associated with each one of processors 102a-c. A first counter is referred to as a CapacityCounter and a second counter is referred to as a ReferenceCounter. Any access to either one of the two leader groups for a processor 102a-c causes the respective ReferenceCounter of the processor 102a-c to be incremented. For each processor 102a-c, the CapacityCounter for the processor is incremented both on a cache hit to the first leader group (i.e., first leader groups g202a_1, g202b_1, and g202c_1 with a positive gradient) as well as, on a cache miss to the second leader group (i.e., second leader groups g202a_2, g202b_2, and g202c_2 with a negative gradient); or conversely, the CapacityCounter is decremented on a cache miss to the first leader group, as well as, on a cache hit in the second leader group.

When the value of the ReferenceCounter of a processor 102a-c exceeds a pre-specified threshold number (e.g., 512, for the sake of one example), an end of an epoch is said to be reached and the probability β for follower sets of the respective processor 102a-c are increased or decreased based on the value of the CapacityCounter at the end of the epoch. In other words, the behavior, in terms of number of hits/misses to leader groups of one epoch may cause a change in the probability β for follower groups to be effected for a following subsequent epoch. At the end of each epoch for each processor of processors 102a-c, the respective two counters, CapacityCounter and ReferenceCounter are reset before these counters are adjusted in the subsequent epoch based on behavior of the leader groups for the processor in the subsequent epoch.

In a simplistic approach, adjusting the probability β based on the value of the CapacityCounter at the end of an epoch may be implemented as increasing β (e.g., by an amount of α if α is a small number such as 10, i.e., β=β+α) if the CapacityCounter is greater than zero or decreasing β (e.g., by an amount of α if α is a small number such as 10, i.e., β=β−α) if the CapacityCounter is less than zero. However, comparing CapacityCounter to zero may lead to frequent fluctuations in the increase or decrease of β at the end of each epoch. It is desirable to reduce or minimize these fluctuations in order to achieve a more stable evaluation of whether β should be increased or decreased.

Accordingly, in exemplary aspects, the CapacityCounter is compared to non-zero threshold values (e.g., 15 and −15, in one illustrative example), and decisions to increase or decrease β are based on this comparison with the non-zero threshold. Specifically, if CapacityCounter is greater than a positive threshold (e.g., +15), β may be increased, and if CapacityCounter is less than a negative threshold (e.g., −15), β may be decreased. Furthermore, in exemplary aspects, since α is selected as 100% to avoid local maxima, the increase or decrease in β may be by a different amount, designated as γ, wherein γ may be a small number (e.g., γ=((1 or 2)*100%)/(number of processors)=((1 or 2)*100%)/3 where there are three processors 102a-c configured to access shared cache 104 in the above example).

In some aspects, it is possible that the adjustment of the probability β for follower sets of processors 102a-c may drop to a very small value tending towards 0% to effectively starve those follower sets from receiving any allocation in shared cache 104. In order to prevent this situation, a minimum value of β may be assigned, e.g., βₘᵢₙ=(100%)/(number of processors)=100%/3 where there are three processors 102a-c configured to access shared cache 104 in the above example. This minimum value βₘᵢₙ may be used as a floor and any decrease of β may be prevented from falling below this minimum value when β is adjusted at the end of each epoch for the respective processors 102a-c. It will be understood that adjusting probability β in this manner to not drop below the minimum value βₘᵢₙ does not mean that each processor's allocation in cache 104 is restricted to a corresponding proportion (e.g., ⅓ in the above example), since β relates to the probability of insertion and promotion of cache lines of the respective processors. Thus, at any point in time, the specific allocation or number of cache lines in cache 104 for each processor may vary (e.g., not limited to a static allocation of ⅓^{rd} of cache 104 to each processor) as the allocation of each processor 102a-c in cache 104 may also be a function of the cache access traffic, which can change dynamically for each processor.

Furthermore in some aspects, non-demand cache lines may be treated differently and less preferentially than demand cache lines from processors 102a-c in terms of the positions in the stack that the non-demand cache lines are assigned. For example, prefetch requests and write-backs to cache 104 from respective processors 102a-c may not be assigned the probability β which would be otherwise assigned by the above processes to demand cache lines upon insertion. In one aspect, the non-demand cache lines may be randomly inserted into a lowest segment of the LRU stack (e.g., a lowest quadrant, such as the last two positions including the LRU position in LRU stack 105c). If there is a hit for one of these non-demand cache lines inserted in this manner, they may be probabilistically promoted to a higher position closer to the MRU position in some aspects.

Accordingly, disclosed aspects are directed to dynamic partitioning of a shared cache (e.g., cache 104) based on hill-climbing, wherein multiple processors or applications configured to access the shared cache are assigned a probability for insertion as well as promotion of respective cache lines in the shared cache, which provides an efficient and fair allocation of the shared cache among the multiple processors and prevents some processors from exceeding their fair share. Additionally, non-demand cache lines are treated less preferentially than demand cache lines by inserting the non-demand cache lines into a low segment of the LRU stack, to prevent encroaching on the share of demand cache lines in the shared cache. Furthermore, by choosing positive and negative gradients of 100 and 0 respectively (i.e., α=100%) for leader groups of respective processors, local maxima in hill-climbing are avoided. In some aspects, a minimum probability βₘᵢₙ is assigned for each processor to prevent undesirable starving of the processors. In some aspects, setting a non-zero threshold for comparing the counter CapacityCounter for each processor at the end of each epoch for making decisions on increasing or decreasing β, fluctuations in β are reduced.

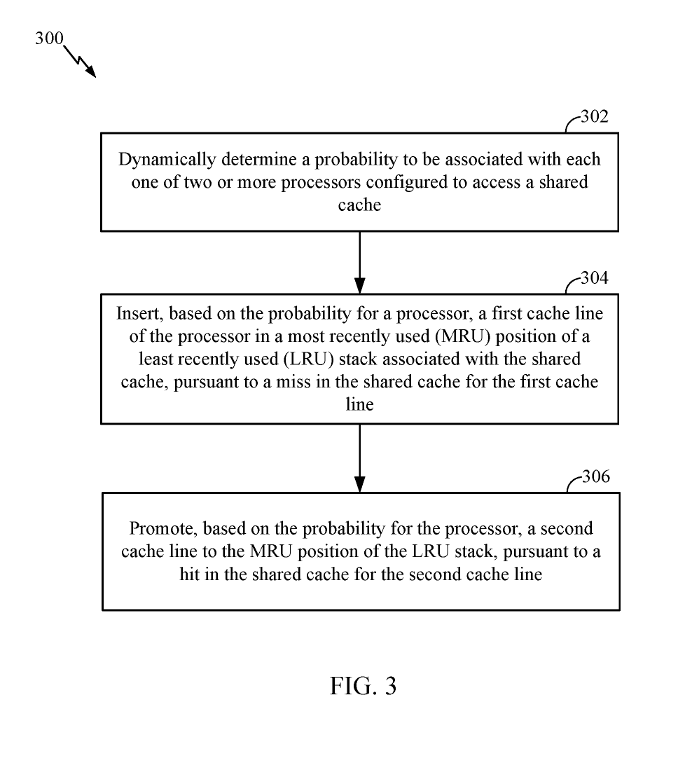

Accordingly, it will be appreciated that exemplary aspects include various methods for performing the processes, functions and/or algorithms disclosed herein. For example, FIG. 3 illustrates a method 300 of method of dynamically partitioning a shared cache (e.g., cache 104).

Block 302 comprises dynamically determining a probability to be associated with each one of two or more processors (e.g., processors 102a-c) configured to access the shared cache. In one example, dynamically determining the probability may be based on hill-climbing comprising assigning an initial probability (β₀) to follower groups of sets of cache lines of the shared cache; assigning a positive gradient probability (e.g., β₁+α=100% where α=100%) to a first leader group of sets of the shared cache (e.g., first leader group g202a_1 for processor 102a), and a negative gradient probability (e.g., β₁−α=0% where α=100%) to a second leader group of sets (e.g., second leader group g202a_2 for processor 102a) of the shared cache; and increasing or decreasing the initial probability at the end of an epoch for the first processor to provide the first probability (β₁), based on whether the first leader group or the second leader group has a better performance at the end of the epoch, for example. Comparing performance of the first and second leader groups can be accomplished by increasing a first counter (CapacityCounter) when there is a hit in the first leader group or a miss in the second leader group and comparing, at the end of the epoch, the value of the first counter to a non-zero threshold (e.g., increasing the initial probability if the value of the first counter is greater than a positive non-zero threshold or decreasing the initial probability if the value of the first counter is less than a negative non-zero threshold, to reduce fluctuations in the first probability). In some aspects, determining the end of the first epoch can be performed by incrementing a second counter (e.g., ReferenceCounter) each time there is an access to the first leader group or the second leader group and comparing a value of the second counter to a threshold value.

Block 304 comprises inserting, based on the probability for a processor (e.g., β₁ for processor 102a), a first cache line (e.g., in one of ways w0-w7 of set 104c of cache 104) of the processor in a most recently used (MRU) position of a least recently used (LRU) stack associated with the shared cache (e.g., LRU stack 105c associated with set 104c), pursuant to a miss in the shared cache for the first cache line.

Block 306 comprises promoting, based on the probability for the processor (e.g., β₁ for processor 102a), a second cache line (e.g., in one of ways w0-w7 of set 104c of cache 104) to the MRU position of the LRU stack (e.g., LRU stack 105c associated with set 104c), pursuant to a hit in the shared cache for the second cache line.

Although not explicitly illustrated, a cache controller or other logic associated with cache 104 may be configured to implement the above functionality of dynamically determining the probability to be associated with each one of two or more processors configured to access the cache 104. The cache controller may further be configured to insert, based on the probability for a processor, a first cache line of the processor in a most recently used (MRU) position of a least recently used (LRU) stack (e.g., stack 105c) associated with the shared cache, pursuant to a miss in the shared cache for the first cache line, and promote, based on the probability for the processor, a second cache line to the MRU position of the LRU stack, pursuant to a hit in the shared cache for the second cache line. As such, the exemplary aspects of this disclosure also include an apparatus comprising the cache controller or other means or processing element for dynamically partitioning a shared cache, including means for performing the functions described above with relation to method 300 of FIG. 3.

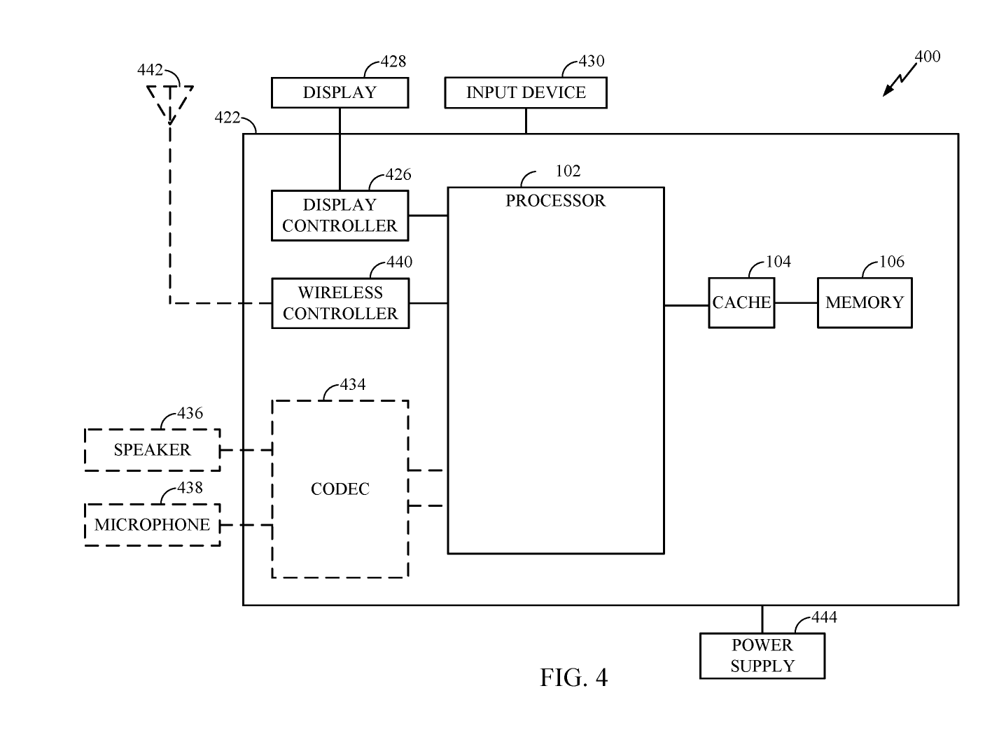

An example apparatus in which exemplary aspects of this disclosure may be utilized, will now be discussed in relation to FIG. 4. FIG. 4 shows a block diagram of computing device 400. Computing device 400 may correspond to an exemplary implementation of a processing system configured to perform method 300 of FIG. In the depiction of FIG. 4, computing device 400 is shown to include processor 102 (which may collectively represent the multiple processors 102a-c) and cache 104 shown in FIG. 1, wherein cache 104 is configured to be dynamically partitioned via hill-climbing according to aspects discussed herein. In FIG. 4, processor 102 is exemplarily shown to be coupled to memory 106 with cache 104 between processor 102 and memory 106 as described with reference to FIG. 1, but it will be understood that other memory configurations known in the art may also be supported by computing device 400.

FIG. 4 also shows display controller 426 that is coupled to processor 102 and to display 428. In some cases, computing device 400 may be used for wireless communication and FIG. 4 also shows optional blocks in dashed lines, such as coder/decoder (CODEC) 434 (e.g., an audio and/or voice CODEC) coupled to processor 102 and speaker 436 and microphone 438 can be coupled to CODEC 434; and wireless antenna 442 coupled to wireless controller 440 which is coupled to processor 102. Where one or more of these optional blocks are present, in a particular aspect, processor 102, display controller 426, memory 106, and wireless controller 440 are included in a system-in-package or system-on-chip device 422.

Accordingly, a particular aspect, input device 430 and power supply 444 are coupled to the system-on-chip device 422. Moreover, in a particular aspect, as illustrated in FIG. 4, where one or more optional blocks are present, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 generally depicts a computing device, processor 102 and memory 106, may also be integrated into a set top box, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include computer readable media embodying a method for dynamically partitioning a shared cache. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of dynamically partitioning a shared cache, the method comprising:
dynamically determining a probability to be associated with each one of two or more processors configured to access the shared cache;
inserting, based on the probability for a processor, a first cache line of the processor in a most recently used (MRU) position of a least recently used (LRU) stack associated with the shared cache, pursuant to a miss in the shared cache for the first cache line; and
promoting, based on the probability for the processor, a second cache line to the MRU position of the LRU stack, pursuant to a hit in the shared cache for the second cache line.

2. The method of claim 1, wherein a cache line associated with the MRU position is least likely to be replaced and a cache line associated with an LRU position of the LRU stack is most likely to be replaced, wherein cache lines of the shared cache are ordered in a descending order from the MRU position to the LRU position in the LRU stack.

3. The method of claim 1, wherein dynamically determining a first probability to be associated with a first processor comprises hill-climbing, by:
assigning an initial probability to follower groups of sets of cache lines of the shared cache;
assigning a positive gradient probability to a first leader group of sets of the shared cache, and a negative gradient probability to a second leader group of sets of the shared cache; and
increasing or decreasing the initial probability at the end of an epoch for the first processor to provide the first probability, based on whether the first leader group or the second leader group has a better performance at the end of the epoch.

4. The method of claim 3, comprising comparing performance of the first and second leader groups by increasing a first counter associated with the first processor when there is a hit in the first leader group or a miss in the second leader group and comparing, at the end of the epoch, the value of the first counter to a non-zero threshold.

5. The method of claim 4, comprising increasing the initial probability if the value of the first counter is greater than a positive non-zero threshold or decreasing the initial probability if the value of the first counter is less than a negative non-zero threshold, to reduce fluctuations in the first probability.

6. The method of claim 3, comprising determining the end of the first epoch by incrementing a second counter associated with the first processor each time there is an access to the first leader group or the second leader group and comparing a value of the second counter to a threshold value.

7. The method of claim 3, wherein the positive gradient probability is 100% and the negative gradient probability is 0%, to prevent local maxima in the first probability.

8. The method of claim 3, comprising setting a minimum value for the first probability and preventing decreasing the first probability from falling below the minimum value, to prevent starving the first processor from storage space on the shared cache.

9. The method of claim 2, comprising for inserting a non-demand cache line into a low segment of the LRU stack.

10. The method of claim 9, further comprising promoting the non-demand cache line based on the probability if there is a hit in the shared cache for the non-demand cache line.

11. The method of claim 9, wherein the non-demand cache line comprises a prefetch or a write-back to the shared cache.

12. An apparatus comprising:
a shared cache configured to be accessed by two or more processors; and
a cache controller configured to dynamically partition the shared cache among the two or more processors, the cache controller configured to:
dynamically determine a probability to be associated with each one of the two or more processors;
insert, based on the probability for a processor of the two or more processors, a first cache line of the processor in a most recently used (MRU) position of a least recently used (LRU) stack associated with the shared cache, pursuant to a miss in the shared cache for the first cache line; and
promote, based on the probability for the processor, a second cache line to the MRU position of the LRU stack, pursuant to a hit in the shared cache for the second cache line.

13. The apparatus of claim 12, wherein a cache line associated with the MRU position is least likely to be replaced and a cache line associated with an LRU position of the LRU stack is most likely to be replaced, wherein cache lines of the shared cache are ordered in a descending order from the MRU position to the LRU position in the LRU stack.

14. The apparatus of claim 12, wherein the cache controller is configured to dynamically determine a first probability to be associated with a first processor based on hill-climbing, wherein:
an initial probability is assigned to follower groups of sets of cache lines of the shared cache;
a positive gradient probability is assigned to a first leader group of sets of the shared cache, and a negative gradient probability to a second leader group of sets of the shared cache; and
the initial probability is increased or decreased at the end of an epoch for the first processor to provide the first probability, based on whether the first leader group or the second leader group has a better performance at the end of the epoch.

15. The apparatus of claim 14, wherein a first counter associated with the first processor is incremented when there is a hit in the first leader group or a miss in the second leader group and, at the end of the epoch, the value of the first counter is compared to a non-zero threshold to provide a comparison of the performance of the first and second leader groups.

16. The apparatus of claim 15, wherein the initial probability is increased if the value of the first counter is greater than a positive non-zero threshold or decreased if the value of the first counter is less than a negative non-zero threshold, to reduce fluctuations in the first probability.

17. The apparatus of claim 14, further comprising a second counter associated with the first processor, wherein the second counter is incremented each time there is an access to the first leader group or the second leader group and a value of the second counter is compared to a threshold to determine an end of the first epoch.

18. The apparatus of claim 14, wherein the positive gradient probability is 100% and the negative gradient probability is 0%, to prevent local maxima in the first probability.

19. The apparatus of claim 14, comprising a minimum value associated with the first probability, wherein the first probability is prevented from falling below the minimum value, to prevent starvation of the first processor from storage space on the shared cache.

20. The apparatus of claim 13, wherein a non-demand cache line is inserted into a low segment of the LRU stack.

21. The apparatus of claim 20, wherein the non-demand cache line is promoted based on the probability if there is a hit in the shared cache for the non-demand cache line.

22. The apparatus of claim 20, wherein the non-demand cache line comprises a prefetch or a write-back to the shared cache.

23. The apparatus of claim 12, integrated in a device selected from the group consisting of a set top box, a music player, a video player, an entertainment unit, a navigation device, a personal digital assistant (PDA), a fixed location data unit, a computer, a laptop, a tablet, a communications device, and a mobile phone.

24. An apparatus comprising:
a shared cache accessible by two or more processors;
means for dynamically determining a probability to be associated with each one of two or more processors;
means for inserting, based on the probability for a processor, a first cache line of the processor in a most recently used (MRU) position of a least recently used (LRU) stack associated with the shared cache, pursuant to a miss in the shared cache for the first cache line; and
means for promoting, based on the probability for the processor, a second cache line to the MRU position of the LRU stack, pursuant to a hit in the shared cache for the second cache line.

25. The apparatus of claim 24, wherein a cache line associated with the MRU position is least likely to be replaced and a cache line associated with an LRU position of the LRU stack is most likely to be replaced, wherein cache lines of the shared cache are ordered in a descending order from the MRU position to the LRU position in the LRU stack.

26. The apparatus of claim 24, comprising means for inserting a non-demand cache line into a low segment of the LRU stack.

27. The apparatus of claim 26, further comprising means for promoting the non-demand cache line based on the probability if there is a hit in the shared cache for the non-demand cache line.

28. A non-transitory computer readable storage medium comprising code, which, when executed by a processing element, causes the processing element to perform operations for dynamically partitioning a shared cache, non-transitory computer readable storage medium comprising:
code for dynamically determining a probability to be associated with each one of two or more processors configured to access the shared cache;
code for inserting, based on the probability for a processor, a first cache line of the processor in a most recently used (MRU) position of a least recently used (LRU) stack associated with the shared cache, pursuant to a miss in the shared cache for the first cache line; and
code for promoting, based on the probability for the processor, a second cache line to the MRU position of the LRU stack, pursuant to a hit in the shared cache for the second cache line.

29. The non-transitory computer readable storage medium of claim 28, wherein a cache line associated with the MRU position is least likely to be replaced and a cache line associated with an LRU position of the LRU stack is most likely to be replaced, wherein cache lines of the shared cache are ordered in a descending order from the MRU position to the LRU position in the LRU stack.

30. The non-transitory computer readable storage medium comprising of claim 28, comprising code for inserting a non-demand cache line into a low segment of the LRU stack.
